(19) United States
(12) Patent Application Publication
(10) Pub. No.: US 2005/0283635 A1
(43) Pub. Date: Dec. 22, 2005

(54) System and method for promoting effective service to computer users

(75) Inventors: Paul Harrison Benson, Raleigh, NC (US); Cory Allen Chapman, Raleigh, NC (US); James Stephen Rutldge, Durham, NC (US); Kenneth Scott Seethaler, Raleigh, NC (US)

Correspondence Address: LENOVO (SINGAPORE) PTE. LTD., BUILDING 675, MAIL C-137, 4401 SILICON DRIVE, DURHAM, NC, 27709, US

(73) Assignee: International Business Machines Corporation, Armonk, NY (US)

(21) Appl. No.: 10/863,106

(22) Filed: Jun. 8, 2004

(51) Int. Cl. G06F 11/00

(52) U.S. Cl. 714/1

(57) ABSTRACT

Operating parameters and potentially related malfunctions are gathered from end users of computer systems and fed into a predictive model to generate predictions of future failures when subsequent operating parameters from end users are fed into the prediction model. Parts may be ordered, service calls scheduled, and sales strategies updated based on predictions of impending malfunctions.

### FIELD OF THE INVENTION

The present invention relates generally to providing computer services to computer end users.

### BACKGROUND

From time to time end user computer system components can malfunction at rates higher than expected. Typically, the malfunctions are observed in the beginning in only a handful of customers. In any case, there is no reliable way to systematically anticipate future similar malfunctions in other end user systems, much less to plan for parts, service calls, and sales strategies that take into account the higher than expected rate of malfunction. Instead, vendors and service providers more or less must behave reactively in responding to malfunctions as they occur, instead of proactively predicting and preventing malfunctions before they happen. This invention addresses the above noted problems.

### SUMMARY OF THE INVENTION

A service method includes receiving data from plural user computer systems. The data represents at least one operating parameter of the user computer systems. The method also includes using the data and information regarding malfunctions, if any, of the user computer systems to establish a predictive model. Subsequently, operating parameter data from the same or other user computer systems can then be received and input to the predictive model to generate predictions of impending malfunctions in the systems.

The non-limiting method may include ordering replacement parts for the user computer systems based on the predictions, scheduling service activities for the user computer systems based on the predictions, and establishing sales activities related to the user computer systems based on the predictions. The operating parameters may include temperature, hours of operation, number of on-off cycles, power consumption, humidity, and voltage. If desired, the predictive model and/or the prediction can be provided to a user as a service. Also, warranty terms can be established for users based on the users agreeing to provide data to the models.

In another aspect, a general purpose computer system executes logic that includes receiving first data representing at least one computer system operating parameter and associated computer system malfunctions. The logic also includes generating at least one predictive model based on the first data, and then receiving second data representing at least one computer system operating parameter. The second data is input to the predictive model, which processes the data and generates a prediction of malfunction.

In yet another aspect, a service includes providing a prediction of a malfunction of a first computer system component based on correlating operating parameters and malfunctions from plural user computer systems with operating parameters of the first computer system.

In still another aspect, a service includes generating a prediction of a malfunction of at least a first computer system component based on correlating operating parameters and malfunctions from plural user computer systems with operating parameters of the first computer system component. Then, the service itself can include ordering replacement parts for the first computer system component, and/or scheduling/establishing service and sales activities.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture; and

FIG. 2 is a flow chart of the present method.

### DETAILED DESCRIPTION OF THE PREFERRED EMBODIMENT

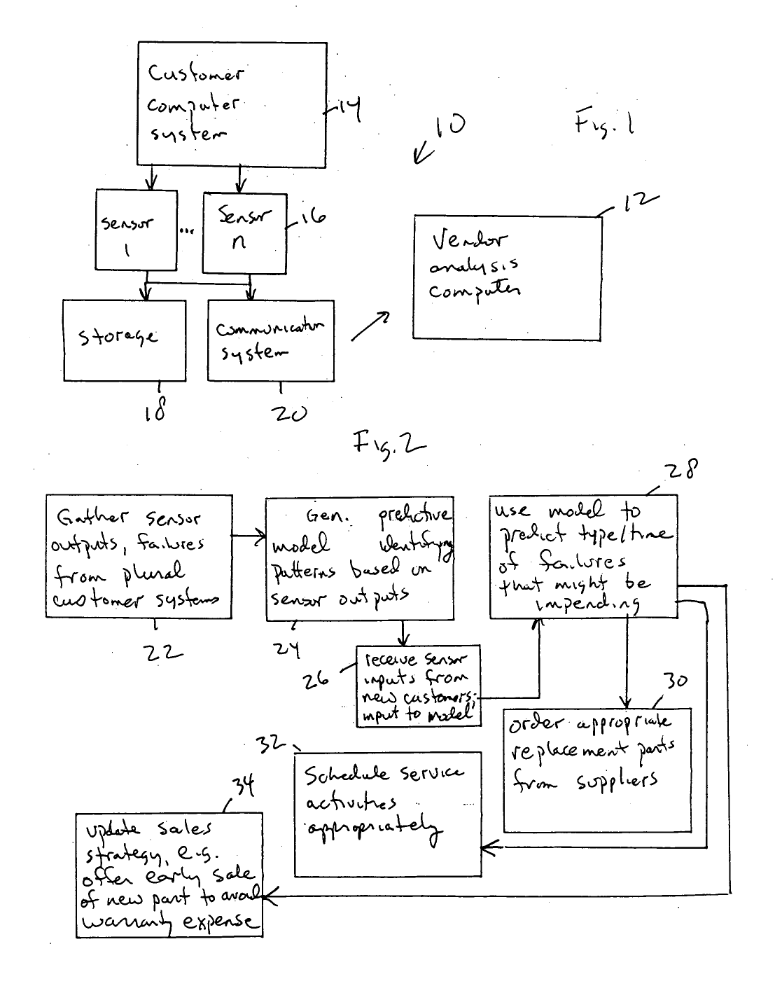

Referring initially to FIG. 1, a computing system is shown, generally designated 10, that includes one or more vendor/service provider analysis computers 12 (only a single computer 12 shown for clarity) that undertakes the predictive modelling set forth further below based on input from plural customer computer systems 14 (only a single customer computer shown for clarity). The computers herein can be any suitable computers, e.g., a personal computer or larger (mainframe), a laptop computer, a notebook computer or smaller, etc.

As shown in FIG. 1, each customer computer system 14 may include plural sensors 16 that sense operating parameters of the computer system 14. These operating parameters can include computer component temperatures (average and/or peak), the total hours of operation of one or more system components since, e.g., a component was placed into service, number of on-off cycles of one or more system components, power consumption of one or more components, both average and, if desired, peak power consumption, humidity within the computer system 14 components and/or facility, and voltages of computer system components, both average and if desired fluctuations. Accordingly, the sensors 16 may include, without limitation, power sensors, voltage sensors, temperature sensors, humidity sensors, and timers, and they can be mounted on circuit boards with, e.g., the central processing unit of the system 14, within a hard disk drive of the system 14, within the power circuit of the system 14, and/or on other peripheral computer system components such as monitors, printers, etc.

The customer computer system 14 may also include storage 18 for storing the outputs of the sensor 16. Also, the customer computer system 14 can include a communication system 20 such as, without limitation, a modem that can communicate over a network such as the Internet with the analysis computer 12. With this structure, it may be appreciated that the operating parameter data output by the sensors 16 can be stored in the storage 18 for retrieval by personnel associated with the vendor analysis computer 12, and/or it can be sent to the analysis computer 12 over the Internet.

Now referring to FIG. 2, commencing at block 22 the operating parameter data from the sensors 16 of preferably plural customer computer systems 14 is gathered in accordance with principles above. Also, information regarding malfunctions, if any, in the systems 14 that generate the parametric data is gathered. For instance, hard disk drive failure incidents may be noted. The information regarding malfunctions can be sent to the analysis computer 12 over the Internet or gathered on site or from warranty claims by personnel, and then input to the analysis computer 12.

Moving to block 24, the parametric data and associated malfunction information is correlated and used to generate a predictive model for outputting predictions of malfunctions. More specifically, a malfunction of a particular customer computer system 14 is associated with the relevant parametric data from that computer system. When more than one type of malfunction exists a predictive model can be developed for each.

The predictive model can be generated using modelling principles known in the art. For example, regression analysis can be used to identify a particular operating parameter value that is correlated with the malfunctions. The analysis to generate the model can be done manually or using neural networks that employ model generation algorithms. In one example, it might happen that a higher than usual number of disk drive failures are discovered to occur at internal disk drive average temperatures exceeding a threshold for a particular period of time. The resulting model in such a circumstance would be to generate a prediction of impending malfunction for systems reporting average temperatures above the threshold. As another example, it might be observed that a higher than usual number of CPU failures are discovered to occur when average power consumption exceeds a threshold and when the rate of on-off cycles exceeds a threshold. The resulting model in such a circumstance would be to generate a prediction of impending malfunction for systems reporting power cycle rates and average power consumption above the respective thresholds. As yet another example, it might be noted that cooling fan failures increase dramatically when total hours of operation exceed a threshold. The examples above are of course illustrative only of various predictive models that can be generated, depending on the facts particular to each system and operating parameter.

Once the predictive models have been generated, additional parametric data from customer computer systems can be received at block 26 and input to the model or models. At block 28, the predictive models analyze the data gathered at block 26 to predict the type and, if desired, expected time of impending malfunctions. For instance, using the first simplified example above, if a customer reports an internal disk drive average temperature that exceeds a threshold for a particular period of time, a prediction can be generated that the disk drive is about to fail.

Proceeding to block 30, when a prediction of a malfunction is output by a prediction model, the necessary replacement parts for the affected computer system can be ordered, so that the parts are available when the failure occurs. Also, service calls can be scheduled at block 32 as appropriate for anticipated failures based on the predictions from the models. Additionally, at block 34 sales strategies can be established or updated based on the predictions of malfunctions from the predictive models. For example, if a prediction exists that a computer system fan is about to fail, an offer to provide and install a new fan can be made preemptively, to avoid the predicted failure. As another example, sales incentives could be offered to customers to accelerate planned computer system acquisitions for components that have been predicted to malfunction soon. In this way, warranty costs can be reduced. Still further, favorable warranty terms can be established for users who agree to provide parametric data as set forth above.

In addition to the above features, services can be offered to users based on the principles set forth herein. For instance, a user might wish to purchase a service contract that would provide for the provision of predictive models and/or predictions relevant to the particular user. Also, ordering replacement parts for users as a service based on the predictions can be undertaken, as can be the scheduling of service calls and sales activities.

While the particular SYSTEM AND METHOD FOR PROMOTING EFFECTIVE SERVICE TO COMPUTER USERS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A method comprising:
receiving data from plural first user computer systems, the data representing at least one operating parameter of at least a portion of the first user computer systems;
using the data and information regarding malfunctions, if any, of the first user computer systems, establishing at least one predictive model;
receiving data from at least one second user computer system, the data representing at least one operating parameter of the second user computer system; and
using the predictive model to generate a prediction of at least one malfunction in the second user computer system based on the data therefrom.

2. The method of claim 1, comprising ordering at least one replacement part for the second user computer system based at least in part on the prediction.

3. The method of claim 1, comprising scheduling at least one service activity for the second user computer system based at least in part on the prediction.

4. The method of claim 1, comprising establishing at least one sales activity related to the second user computer system based at least in part on the prediction.

5. The method of claim 1, wherein the operating parameter is selected from the group of parameters consisting of: temperature, hours of operation, number of on-off cycles, power consumption, humidity, and voltage.

6. The method of claim 1, comprising providing at least one of: the predictive model, and the prediction, to at least one user as a service.

7. The method of claim 1, comprising establishing warranty terms for at least one user based at least in part on the user agreeing to provide data representing at least one operating parameter.

8. A general purpose computer system executing logic comprising:
receiving first data representing at least one computer system operating parameter and associated computer system malfunction;
generating at least one predictive model based on the first data;
receiving second data representing at least one computer system operating parameter;
inputting the second data to the predictive model; and
executing the predictive model to generate at least one prediction of malfunction.

9. The system of claim 8, wherein the operating parameter is selected from the group of parameters consisting of: temperature, hours of operation, number of on-off cycles, power consumption, humidity, and voltage.

10. The system of claim 9, wherein the operating parameter is received over the Internet.

11. A general purpose computer system comprising:
means for receiving first data representing at least one computer system operating parameter and associated computer system malfunctions;
means for generating at least one predictive model based on the first data;
means for receiving second data representing at least one computer system operating parameter;
means for inputting the second data to the predictive model; and
means for executing the predictive model to generate at least one prediction of malfunction.

12. A service, comprising:
providing a prediction of a malfunction of at least a first computer system component associated with a first user based at least in part on correlating operating parameters and malfunctions from plural user computer systems with at least one operating parameter of the first computer system component.

13. The service of claim 12, comprising ordering at least one replacement part for the first computer system component based at least in part on the prediction.

14. The service of claim 12, comprising scheduling at least one service activity for the first computer system component based at least in part on the prediction.

15. The service of claim 12, comprising establishing at least one sales activity related to the first computer system component based at least in part on the prediction.

16. The service of claim 12, wherein the operating parameter is selected from the group of parameters consisting of: temperature, hours of operation, number of on-off cycles, power consumption, humidity, and voltage.

17. The service of claim 12, comprising providing at least one of: the predictive model, and the prediction, to the first user.

18. The service of claim 12, comprising establishing warranty terms for at least one user based at least in part on the user agreeing to provide data representing at least one operating parameter.

19. A service, comprising:
generating a prediction of a malfunction of at least a first computer system component associated with a first user based at least in part on correlating operating parameters and malfunctions from plural user computer systems with at least one operating parameter of the first computer system component; and
providing at least one service to the first user selected from the group of services consisting of:
ordering at least one replacement part for the first computer system component based at least in part on the prediction;
scheduling at least one service activity for the first computer system component based at least in part on the prediction;
establishing at least one sales activity related to the first computer system component based at least in part on the prediction.
